(19) United States
(12) Patent Application Publication
(10) Pub. No.: US 2017/0088394 A1
(43) Pub. Date: Mar. 30, 2017

(54) CONTROL SYSTEM FOR AN ELEVATOR SYSTEM, ELEVATOR SYSTEM AND METHOD OF OPERATING AN ELEVATOR SYSTEM

(71) Applicants: ThyssenKrupp Elevator AG, Essen (DE); ThyssenKrupp AG, Essen (DE)

(72) Inventors: Rory Smith, El Cajon, CA (US); Stefan Gerstenmeyer, Filderstadt (DE); Stefan Schneider, Filderstadt (DE)

(73) Assignees: ThyssenKrupp Elevator AG, Essen (DE); ThyssenKrupp AG, Essen (DE)

(21) Appl. No.: 15/312,136

(22) PCT Filed: May 13, 2015
(86) PCT No.: PCT/EP2015/060624

§ 371 Date: Nov. 17, 2016

(30) Foreign Application Priority Data
May 26, 2014 (EP) 14169876.1

(51) Int. Cl. B66B 1/24; B66B 9/00; B66B 1/46; B66B 3/00

(52) U.S. Cl. CPC B66B 1/2458; B66B 3/006; B66B 9/00; B66B 1/468; B66B 2201/103; B66B 2201/233

(57) ABSTRACT

A control system for an elevator system may comprise elevator cars and an elevator control for assigning elevator cars to destination calls. In a first mode of operation, the elevator control may be adapted to determine and assign an elevator car to transport a passenger based on at least one elevator car determination criterion. The elevator control may wait to provide information identifying the elevator car assigned to the passenger until the assigned elevator car approaches or arrives at a floor on which the passenger is located. Waiting to provide such information permits the elevator control to modify which elevator car ultimately transports the passenger based on intervening factors such as a door being held on an elevator car that was initially assigned to transport the passenger. In a second mode of operation, the passenger may be provided with the information that identifies the assigned elevator car immediately after the destination call is placed. In a third mode of operation, up/down calls may be placed.”

### BACKGROUND OF THE INVENTION

1. Field of the Invention

The present invention relates to elevator systems having a plurality of elevator cars that operate in a plurality of elevator shafts and that serve a plurality of elevator landings. In particular, the present invention provides a method for optimizing designations of individual elevator cars to destination calls made by passengers.

2. Description of the Related Art

U.S. Pat. No. 6,439,349 B1 describes a control system algorithm for elevator systems that, in a first mode of operation, can use destination input devices of a destination input system at all landings, some landings or no landings. This system, also known as destination control system, is an intelligent control system, in which passengers select their destination on a destination input device before entering an elevator car.

One of the limitations of such destination selection control systems according to the prior art is that they immediately advise a passenger, which elevator car of the plurality of elevator cars he is to use. This requires a decision, which elevator car to assign to the destination call, to be made by the system solely based on the current traffic condition, i. e. at the moment in which the passenger enters his destination call into the system. However, as experience shows, traffic conditions within a multi story elevator system can change even within short time frames. This can have the effect that a user will have to wait for the elevator car designated (assigned) to his destination call for a substantially longer time than initially calculated by the system. Obviously, the longer the time frame is, for example due to heavy elevator traffic, the more significant effects of changing traffic conditions can become.

To give an example: Be it assumed that passenger A in the lobby is assigned, upon entering a destination call, an elevator car #2 of a plurality of elevator cars #1 to #n based upon the dispatch algorithm for example as described in U.S. Pat. No. 6,439,349 B1. However, if another passenger B already using elevator car #2 on another landing holds the door of elevator car #2 open whilst talking to a colleague, this might cause a delay for elevator car #2, so that this no longer constitutes the optimal solution for passenger A. However, elevator car #2 has already been assigned to passenger A, and a change to this assignment, is, in practice, hardly possible.

The algorithm described in U.S. Pat. No. 6,439,349 B1 also allows a second mode of operation, in which the destination selection control is deactivated, and the input devices are furnished with classic up/down buttons. In this second mode of operation, re-assignments of elevator cars to accommodate changing traffic conditions are more easily possible. However, the second mode of operation is more inefficient than the first mode of operation in that the system receives no information regarding passenger destination prior to a passenger actually entering the elevator car.

The invention thus seeks to optimize performance of elevator systems comprising a plurality of elevator cars serving a plurality of elevator landings.

### SUMMARY OF THE INVENTION

The present invention thus suggests a control system for an elevator system comprising the features of claim 1, an elevator system comprising the features of claim 10, and a method of operating an elevator system comprising the features of claim 14.

The present invention overcomes the limitations of the prior art. According to the invention, it is possible to optimize the response of an elevator control system to a destination selection call (also simply referred to as destination call) made by a passenger, in that, taking into account the destination landing selected by a passenger, the elevator control is adapted to determine and assign an elevator car, which the passenger shall use, based on at least one elevator car determination criterion, the determined elevator car not being communicated to the passenger (as the elevator car assigned to his destination selection call) until or until shortly before the determined elevator car arrives at the entrance landing, i.e. the landing at which the passenger has made his destination selection call. This provides enhanced flexibility over prior art systems as, especially, an initial assignment of an elevator car to a destination selection call can be modified, again based at least one elevator car determination criterion. Such an criterion can, for example, be an estimated time of arrival, an estimated transport time from the entrance landing to the destination landing, the state of occupancy of elevator cars etc. Be it noted in this connection that the terms “determination” and “assignment” essentially refer to the same or similar concept, “determination” reflecting the computational operation of the elevator control, “assignment” then being the result of this determination. Also, there are grammatical constructions, where usage of only one of the terms seems more suitable.

“Shortly before”, in the described context, can, for example, mean 1, 2, 3, 4, 5 seconds, or even up to 10 seconds before arrival.

Advantageously, a passenger is informed that an elevator car, which he shall use, i.e. which has been or will be assigned to his destination call, will be indicated to him when or shortly before this elevator car arrives at the entrance landing. This information can be communicated to the passenger when, or shortly after, he enters his destination selection call. “Shortly after” can mean, for example, up to 1 second or up to 2 seconds after he makes his destination selection call.

Preferably, an indication to the passenger is generated to use the next elevator car to arrive at the entrance or call landing, i. e. the landing at which the user enters his destination selection call, the travelling direction of which corresponds to the direction of the destination landing relative to the embraced landing.

The system is thus capable of modifying an initial choice for an elevator car, which the passenger shall use. For example, if the door of an elevator car initially assigned to a destination selection call by the elevator control system is held open on another landing before it arrives at the entrance landing for the passenger in question, the system can modify its assignment of elevator car to be used by the passenger. This assignment and re-assignment is performed in the background, i. e. the passenger is only informed about the (final) assignment when or just before the finally assigned elevator car arrives at the entrance landing. This avoids the necessity of any kind of mental readjustment on the part of the passenger, and thus offers simple handling of the elevator system for a passenger. To operate in this mode, the elevator cars need not be provided with input devices, via which a passenger could enter co-destination calls from inside the elevator car. It is, however, expedient to provide displays acting as reassurance indicators, which, for example, can show registered destinations to passengers inside the elevator car.

It is especially advantageous if, in addition to this first mode of operation, there is provided a second mode of operation, in which the control system generates an indication for the passenger, which (specific) elevator car to use, after he has made the destination call. Especially, this indication can be given essentially immediately after he has made the destination call, for example within 0.5 sec, 1 sec, 2 sec or 5 sec of making the call. This second mode of operation essentially corresponds to classic destination selection control as is known from the prior art. In case an elevator system can operate only in the first or second mode of operation, it is again not necessary to provide an input device for destination calls within an elevator car. Here again, it is expedient to provide displays which can be used as reassurance indicators.

According to a further advantageous embodiment, the control system according to the invention can also operate in a third mode of operation, in which only up or down calls can be entered on respective landings. Obviously, if this third mode of operation is also implemented, the elevator cars will be provided with destination input means such as touchscreens or push buttons. Advantageously, a display in an elevator car used as a reassurance indicator for the first and second mode of operation can be adapted for use as an input device for the third mode of operation. For example, in case of use of a touchscreen as a display, this can be usable exclusively as a (passive) display device during the first and second mode of operation, and as an (active) input device during the third mode of operation.

It is especially advantageous to adapt the control system according to the invention to be able to select between the first and the second and the third mode of operation for each landing the elevator system services, taking into account at least one parameter such as a control or status parameter.

Such a control parameter can, for example, be the type of landing in question. For example, a main lobby landing can be assigned the second mode of operation (classic destination selection control) at all times.

Further landings, to which the second mode of operation can constantly be assigned, are, for example, landings such as restaurant landings or car park (garage) landings. However, it is also possible to assign the first mode of operation to these landings at all times.

Higher located landings, for example landing towards the top of a building, can be assigned the first mode of operation for example at all times or only in times of lighter traffic, and the second mode of operation in times of heavier traffic.

Further examples for such control parameters, which can be taken into account on their own or in combination, are for example assignment criteria or rules known from the prior art. These can be based on or include for example a cost function, for example taking into account an estimated time of arrival (ETA). They can also take into account destination calls already being processed in the system or the load of individual elevator cars. A further criterion which can be taken into account is, whether a specific elevator car services a landing in question or not, as well as a prediction regarding an estimated destination call load.

Typical status parameters are, for example, times to which certain modes of operation are assigned. For example, a mode can be changed at specific times of day. The distinction between control parameters and status parameters is not always easily possible. For example, a change of mode envisaged for a certain time of day can be made dependent on current traffic, traffic forecasts or monitoring signals. Such a parameter has characteristics of both control and status parameters.

Advantageously, the indications to a passenger in connection with the first mode of operation are provided by means of hall lanterns, especially including up/down arrows above or beside the respective elevator car entrance.

Advantageously, an audible chime can alternatively or additionally announce the arrival of an elevator car at a landing.

Under certain circumstances, an indication to a passenger, which elevator car to use, can be given when the arrival of an elevator car at a landing has already been indicated (e.g. due to a previous destination call), or such an elevator car is already standing/waiting at the entrance landing in question. So, even if basically the first mode of operation is currently assigned to a landing, i. e. destination calls entered at this landing are processed according to the first mode of operation, the system can send a passenger directly to the arriving elevator car by means of a corresponding indication, e. g. an indication on the destination input device, which specific elevator car to use.

Advantageously, the destination selection control system according to the invention is provided on all landings served by an elevator system. Especially destination selection input devices can be provided at each landing.

Advantageously, there are no further destination input means, e. g. push buttons, within the elevator cars. This ensures that all elevator calls must be made on respective landings, thus increasing efficiency of the elevator system as a whole.

However, it can also be advantageous to provide each elevator car with a device adapted to be usable as a display and/or a destination input means. For example, if an elevator system can only operate in the first or second mode of operation, it is not necessary, but still advisable to provide the inside of the elevator cars with displays which can act as reassurance indicators to display destinations within the elevator car. If the elevator system can also operate in the third mode of operation, it is necessary to provide destination input mean within an elevator cabin. Advantageously, combined devices, i.e. devices which can function as a display or a destination input means depending on specific circumstances, can be used. For example, touchscreens can be adapted to be able to operate as a display, or as a destination input means.

To summarize the main advantage of the present invention over prior art solutions, the control system according to the invention has more information, i. e. passenger destinations, at its disposal than classic up-down-input-systems before respective passengers enter the elevator cars. Also, while classic destination selection control systems have to make an immediate decision which elevator car to assign to a passenger, this is not necessary according to the present invention, and the additional information available will facilitate efficient decision making by the control system.

It is also possible to implement the first and second modes of operations simultaneously on one elevator landing. For example, upward destination calls can be processed according to the first mode of operation, and downward destination calls according to the second mode of operation, or vice versa.

It also possible to implement the first or second modes of operation together with the third mode of operation simultaneously on an elevator landing. For example, on a specific elevator landing, upward calls can be processed according to the first or second mode of operation, and downward calls according to the third mode of operation, or vice versa. As follows from the above, only destinations calls processed according to the second mode of operation will lead to an indication to the passenger at the call input/registration station at the landing, which elevator car he shall use. In case destination calls are processed according to the first or third mode of operation, an indication, which elevator car to use, is given directly at the corresponding elevator shaft, when or shortly before the elevator car arrives.

The invention can be realised in connection with touchscreens on the elevator landings. I. e., the destination call input devices can be provided as touchscreens. According to the mode of operation selected, indications provided by such touchscreens can be easily varied and modified. Advantageously, touchscreens are provided on each elevator landing.

Input devices can also be provided in any other expedient way, for example in form of keypads.

Each elevator landing will usually be provided with one or two of such destination selection input devices, i. e. a plurality of elevator cars will be assigned to each of these destination selection input devices.

Further advantageously, there are provided hall lantern devices on each elevator landing. Such hall lantern devices are provided for each elevator car individually, for example in form of up/down-indicators, including for example up/down arrows.

Further advantages and embodiments of the invention will become apparent from the description and the appended figures.

It should be noted that the previously mentioned features and the features to be further described in the following are usable not only in the respectively indicated combination, but also in further combinations or taken alone, without departing from the scope of the present invention.

### BRIEF DESCRIPTION OF THE DRAWINGS

FIG. 1 shows an elevator system in which, for an exemplary landing, a destination selection control system operates in the first mode of operation, and

FIG. 2 the elevator system of FIG. 1, in which, for exemplary landings, the control system operates in the second mode of operation or the third mode of operation.

### DETAILED DESCRIPTION OF THE INVENTION

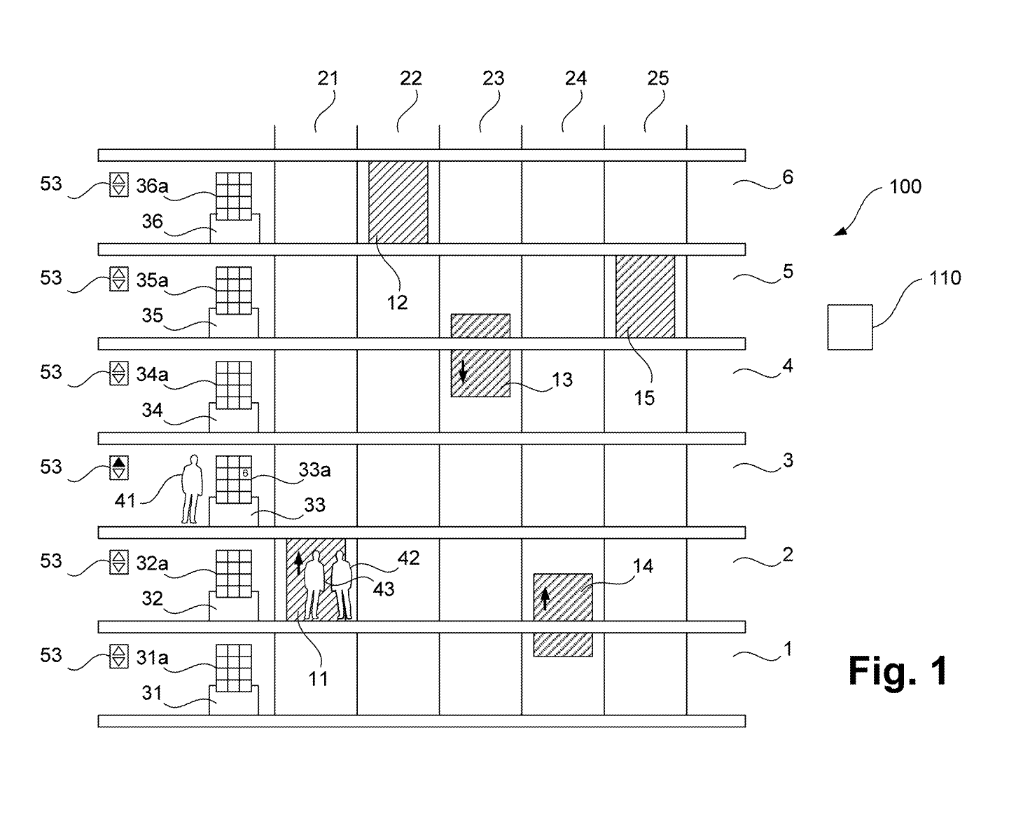

Referring to FIG. 1, an elevator system 100 comprises a plurality of elevator cars 11, 12, 13, 14, 15 moveable in a corresponding plurality of elevator shafts 21, 22, 23, 24, 25. The elevator cars are available to pick up passengers at various landings (floors) 1, 2, 3, 4, 5, 6.

Each of the various elevator landings 1, 2, 3, 4, 5, 6 is provided with a hall call entry device 31-36, each comprising a destination selection input device 31a-36a, by means of which passengers can enter destination calls on landings. The destination selection input devices 31a-36a are interfaced with a (schematically indicated) elevator control 110 via standard connection means such as cables (not shown).

Be it assumed that a passenger 41 on an elevator landing 3 enters a destination call into destination selection input device 33a. In the example given in FIG. 1, be it assumed that passenger 41 wishes to be transported from landing 3 to landing 6.

Instead of immediately assigning one of the elevator cars 11-15 to this destination call and giving the passenger a corresponding indication, as would occur in prior art destination selection control systems, passenger 41 will be advised to use the next elevator car, which stops at landing 3 and is travelling in the same direction as landing 6 relative to landing 3 (i. e. the upward direction). This indication is displayed on the destination selection input device 33a. Only when a suitable elevator car arrives at landing 3 will a corresponding indication be generated for the passenger, for example by illuminating an up-arrow of a hall lantern 53 assigned to the elevator shaft in which the elevator car selected by the elevator control 110 is provided. Such hall lanterns are typically assigned to each elevator shaft, This allows the elevator control 110 to modify the determination or assignment of a suitable elevator car in dependence of current or changing traffic circumstances. For example, in the situation depicted in FIG. 1, elevator car 11 is in landing 2, and thus the elevator car the closest to landing 3, when the destination call is entered by passenger 41. Also, be it assumed that elevator car 11 is travelling in the upward direction as, for example, passenger 43 already in elevator car 11 wishes to be transferred to elevator landing 5.

Thus, initially, elevator car 11 is assigned to the destination call entered by passenger 41 at landing 3.

However, be it also assumed in example that the elevator door of elevator car 11 is being kept open, for example by a further person 42 standing in a light barrier, and wishing to talk to passenger 43.

This information (door held open) is available to elevator control 110, which can then calculate/estimate that maintaining the assignment of elevator car 11 to the destination call entered by passenger 41 at landing 3 will lead to a longer waiting time and later estimated time of arrival ETA. The elevator control can then calculate and generate a re-assignment, and e. g. assign elevator car 14, which is also relatively near to elevator landing 3 and also travelling in the upward direction.

Only when elevator car 14 arrives at landing 3 (or shortly before, for example 1 sec or 2 sec or 3 sec before) will a corresponding indication by means of hall lantern 53 be provided for passenger 41. Thus, the elevator control 110 as described is capable of modifying elevator car designations depending on current traffic circumstances, at the same time not requiring the passenger 41 to process any kind of complex, i. e. changing, information. Thus, confusion of passengers such as passenger 41 is completely avoidable.

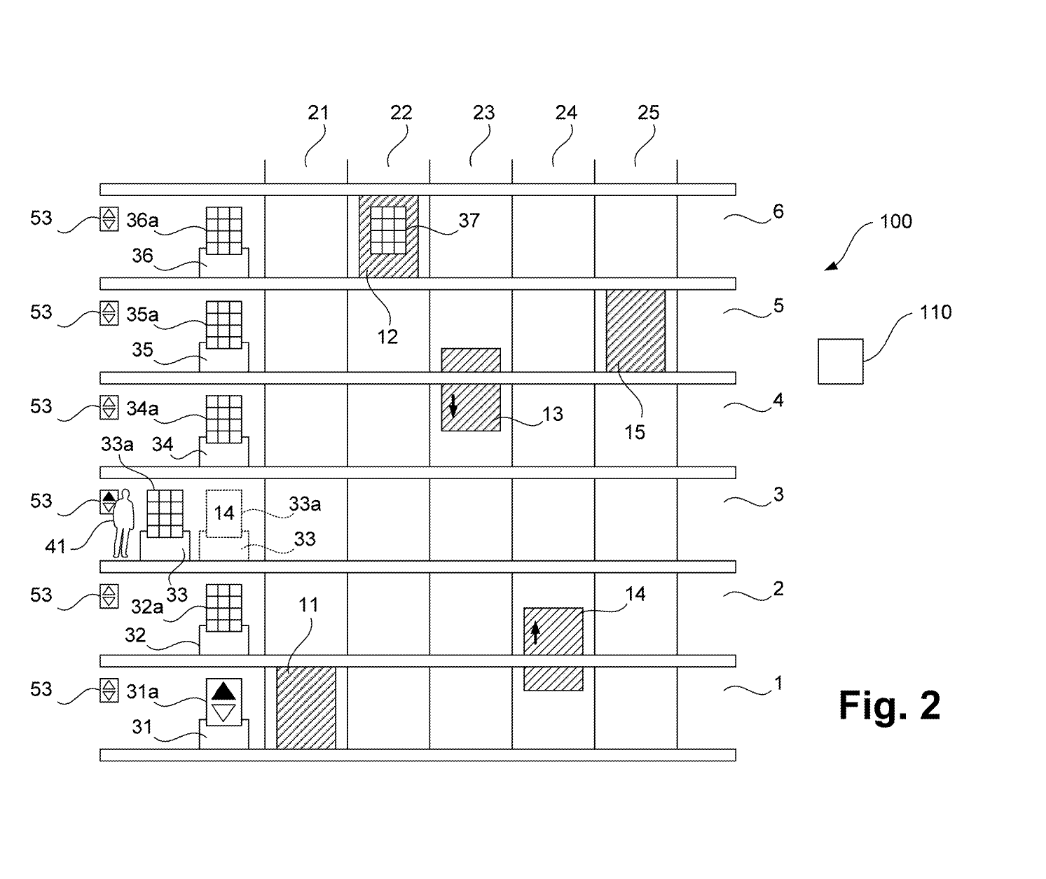

Referring now to FIG. 2, it will be described how, in certain elevator landings, the second and/or the third modes of operation, as referenced in the claims, can be implemented.

Be it assumed that in the situation shown in FIG. 2 elevator landings 2, 4, 5 and 6 are operating in the first mode of operation, i. e. have been assigned the first mode of operation by elevator control 110.

At the same time, elevator landing 3 shall be assumed to operate in the second mode of operation. Herein, a passenger 41 enters a destination call via destination selection input device 33a. As the elevator control 110 has assigned the second mode of operation to elevator landing 3, passenger 41 immediately receives an indication, which elevator car to use to be transported to his destination. In the example shown, destination selection device 33a is additionally shown in dotted lines, to indicate the changed display which is generated after entering the destination call. It displays to the passenger the number of the elevator car to use, i. e. 14 in the example shown.

For example, the destination selection input device 33a can be provided as a touchscreen. This will initially present fields representing each elevator landing, which can be selected by touching the respective fields. Such a touchscreen can then, after input of a destination selection call by passenger 41 and corresponding processing by control 110, present the number of the elevator to be used by the passenger.

The third mode of operation is implemented in elevator landing 1. Here, the destination selection input device has been replaced by or is provided as a traditional up/down-selection device. Again, in case of usage of touchscreens, such touchscreens can be adapted to function as destination selection input devices as described above in connection with the first or second mode of operation, as well as up/down-input-devices in combination with the third mode of operation. In case the third mode of operation is implemented on at least one elevator landing, it is necessary to provide destination selection means within the elevator cars. Such a destination selection means is indicated for elevator cars 12 in FIG. 2 and designated 37. Such a means can be provided as a touchscreen, which can operate as (active) destination selection means during the third mode of operation, but also as (passive) display device, for example as a reassurance indicator for passengers in the elevator car, during the first and second mode of operation.

1.-15. (canceled)

16. A control system for an elevator system comprising elevator cars and an elevator control for assigning the elevator cars to destination calls, wherein the elevator control is adapted in a first mode of operation to determine and assign one of the elevator cars for a passenger to use based on at least one elevator car determination criterion, wherein information that identifies the elevator car assigned to the passenger is not provided to the passenger until the assigned elevator car approaches or arrives at a floor on which the passenger is located.

17. The control system of claim 16 wherein in the first mode of operation a traveling direction of the assigned elevator car corresponds to a direction of a destination floor relative to the floor on which the passenger is located.

18. The control system of claim 17 wherein upon input of a destination call in the first mode of operation, the passenger is informed that the information that will identify the elevator car assigned to the passenger will be provided to the passenger as the assigned elevator car approaches or arrives at the floor on which the passenger is located.

19. The control system of claim 17 wherein upon input of a destination call in the first mode of operation, the passenger is provided with an indication for the passenger to use a next elevator car that arrives to the floor on which the passenger is located.

20. The control system of claim 16 wherein in the first mode of operation the elevator control is capable of modifying which of the elevator cars is assigned to the passenger up until the information that identifies the assigned elevator car is provided to the passenger.

21. The control system of claim 16 wherein the elevator control is adapted in a second mode of operation to provide the passenger with the information that identifies the assigned elevator car immediately after the passenger makes a destination call rather than waiting until the assigned elevator car approaches or arrives at a floor on which the passenger is located.

22. The control system of claim 21 wherein the elevator control is adapted in a third mode of operation to receive an elevator call through an up/down-call-device.

23. The control system of claim 22 wherein the elevator control is capable of selecting the first mode of operation or the second mode of operation and the third mode of operation simultaneously for at least one floor.

24. The control system of claim 22 wherein for each floor the elevator control selects the first mode of operation, the second mode of operation, or the third mode of operation based on at least one control parameter.

25. The control system of claim 24 wherein each floor operates in the first mode of operation, the second mode of operation, the third mode of operation, or the first and second modes of operation, wherein for a floor operating in the first and second modes of operation
upward destination calls operate in the first mode of operation and downward destination calls operate in the second mode of operation, or
upward destination calls operate in the second mode of operation and downward destination calls operate in the first mode of operation.

26. The control system of claim 16 wherein the elevator control is adapted to provide an indication to the passenger which of the elevator cars to use when it is determined that the elevator car to be used has already been indicated due to a prior destination call or if the elevator car to be used is already waiting at the floor on which the passenger is located.

27. An elevator system comprising:
elevator cars that service multiple floors; and
an elevator control for assigning the elevator cars to destination calls, wherein the elevator control is adapted in a first mode of operation to determine and assign one of the elevator cars for a passenger to use based on at least one elevator car determination criterion, wherein information that identifies the elevator car assigned to the passenger is not provided to the passenger until the assigned elevator car approaches or arrives at a floor on which the passenger is located.

28. The elevator system of claim 27 wherein in the first mode of operation the elevator control is capable of modifying which of the elevator cars is assigned to the passenger up until the information that identifies the assigned elevator car is provided to the passenger.

29. The elevator system of claim 27 further comprising a destination selection input device disposed at each of the multiple floors serviced by the elevator cars, wherein each destination input device comprises a touchscreen.

30. The elevator system of claim 27 further comprising a hall lantern device disposed at each shaft on each of the multiple floors serviced by the elevator cars.

31. The elevator system of claim 27 wherein each elevator car comprises a device adapted to be usable as at least one of a display device or a destination call input device.

32. A method of operating an elevator system comprising elevators cars that serve multiple floors, wherein in a first mode of operation the method comprises:
receiving a destination call from a passenger located on an entrance floor;
determining and assigning an elevator car to transport the passenger based on at least one elevator car determination criterion; and
providing information that identifies the assigned elevator car to the passenger as the assigned elevator car approaches or arrives at the entrance floor.

33. The method of claim 32 wherein the at least one elevator car determination criterion is based on which of the elevator cars reaches the entrance floor first.

34. The method of claim 32 further comprising modifying which elevator car is assigned to the passenger at any point up until the information that identifies the assigned elevator car is provided to the passenger.

35. The method of claim 32 wherein in a second mode of operation the method comprises providing the passenger with the information that identifies the assigned elevator car immediately after the destination call is received rather than providing the information that identifies the assigned elevator car as the assigned elevator car approaches or arrives at the entrance floor, wherein in a third mode of operation the method comprises receiving an up/down call.
